(19) United States
(12) Patent Application Publication
(10) Pub. No.: US 2024/0062043 A1
(43) Pub. Date: Feb. 22, 2024

(54) ZERO-SHOT DOMAIN GENERALIZATION WITH PRIOR KNOWLEDGE

(71) Applicant: NEC Laboratories America, Inc., Princeton, NJ (US)

(72) Inventors: Liang Tong, Lawrenceville, NJ (US); Zhengzhang Chen, Princeton Junction, NJ (US); Wei Cheng, Princeton Junction, NJ (US); Haifeng Chen, West Windsor, NJ (US); Zhuohang Li, Knoxville, TN (US)

(21) Appl. No.: 18/364,746

(22) Filed: Aug. 3, 2023

Related U.S. Application Data
(60) Provisional application No. 63/399,715, filed on Aug. 21, 2022.
(60) Provisional application No. 63/399,739, filed on Aug. 22, 2022.

(51) Int. Cl. G06N 3/0455; G06N 3/08

(52) U.S. Cl. CPC G06N 3/0455; G06N 3/08

(57) ABSTRACT

A computer-implemented method for employing a graph-based adaptive domain generation framework is provided. The method includes, in a training phase, performing domain prototypical network training on source domains, constructing an autoencoding domain relation graph by applying a graph autoencoder to produce domain node embeddings, and performing, via a domain-adaptive classifier, domain-adaptive classifier training to make an informed decision. The method further includes, in a testing phase, given testing samples from a new source domain, computing a prototype by using a pretrained domain prototypical network, inferring node embedding, and making a prediction by the domain-adaptive classifier based on the domain node embeddings.

### RELATED APPLICATION INFORMATION

This application claims priority to Provisional Application No. 63/399,715 filed on Aug. 21, 2022, and Provisional Application No. 63/399,739 filed on Aug. 22, 2022, the contents of both of which are incorporated herein by reference in their entirety.

### BACKGROUND

### Technical Field

The present invention relates to machine learning models, and, more particularly, to zero-shot domain generalization with prior knowledge.

### Description of the Related Art

Machine learning models may suffer poor generalizability if there exists a distributional shift between the training data and the testing data. For instance, a neural network trained for predicting the status of an optical network using data collected in a lab environment may not perform well when deployed at the client's side if the configuration of the optical network is changed. The task of leveraging training data collected from several development environments (referred to as the source domains) to train a machine learning model that can generalize to an unseen deployment environment (referred to as the target domain) is termed as “domain generalization.” Since the target domain data is unavailable in the development phase, most conventional domain generalization methods seek to improve the model generalizability by only leveraging the information extracted from the source domain data. However, in practice, oftentimes the target domain is not completely unknown, instead, some types of prior knowledge about the target domain are held before deployment. For instance, in an optical network, a user may know the configuration of the target network in terms of the type of transceivers, the type of modulation, and desired amount of light power, etc.

### SUMMARY

A method for employing a graph-based adaptive domain generation framework is presented. The method includes, in a training phase, performing domain prototypical network training on source domains, constructing an autoencoding domain relation graph by applying a graph autoencoder to produce domain node embeddings, and performing, via a domain-adaptive classifier, domain-adaptive classifier training to make an informed decision. The method further includes, in a testing phase, given testing samples from a new source domain, computing a prototype by using a pretrained domain prototypical network, inferring node embedding, and making a prediction by the domain-adaptive classifier based on the domain node embeddings.

A non-transitory computer-readable storage medium comprising a computer-readable program for employing a graph-based adaptive domain generation framework is presented. The computer-readable program when executed on a computer causes the computer to perform the steps of, in a training phase, performing domain prototypical network training on source domains, constructing an autoencoding domain relation graph by applying a graph autoencoder to produce domain node embeddings, and performing, via a domain-adaptive classifier, domain-adaptive classifier training to make an informed decision. The computer-readable program when executed on a computer causes the computer to, in a testing phase, given testing samples from a new source domain, compute a prototype by using a pretrained domain prototypical network, infer node embedding, and make a prediction by the domain-adaptive classifier based on the domain node embeddings.

A system for employing a graph-based adaptive domain generation framework is presented. The system includes a processor and a memory that stores a computer program, which, when executed by the processor, causes the processor to, in a training phase, perform domain prototypical network training on source domains, construct an autoencoding domain relation graph by applying a graph autoencoder to produce domain node embeddings, and perform, via a domain-adaptive classifier, domain-adaptive classifier training to make an informed decision. The system further includes, in a testing phase, given testing samples from a new source domain, compute a prototype by using a pretrained domain prototypical network, infer node embedding, and make a prediction by the domain-adaptive classifier based on the domain node embeddings.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram of a training phase of a graph-based adaptive domain generation framework, in accordance with embodiments of the present invention;

FIG. 2 is a block/flow diagram of a testing phase of the graph-based adaptive domain generation framework, in accordance with embodiments of the present invention;

FIG. 3 is a block/flow diagram of an exemplary flow chart of the training procedure, in accordance with embodiments of the present invention;

FIG. 4 is a block/flow diagram of an exemplary flow chart of the inference procedure, in accordance with embodiments of the present invention;

FIG. 5 is a block/flow diagram of an exemplary workflow of the domain generalization with prior knowledge and domain adaptive classification, in accordance with embodiments of the present invention;

FIG. 6 is a block/flow diagram of an exemplary practical application of the graph-based adaptive domain generation framework, in accordance with embodiments of the present invention;

FIG. 7 is a block/flow diagram of an exemplary processing system for employing the graph-based adaptive domain generation framework, in accordance with embodiments of the present invention; and

FIG. 8 is a block/flow diagram of an exemplary method for employing the graph-based adaptive domain generation framework, in accordance with embodiments of the present invention.

### DETAILED DESCRIPTION OF PREFERRED EMBODIMENTS

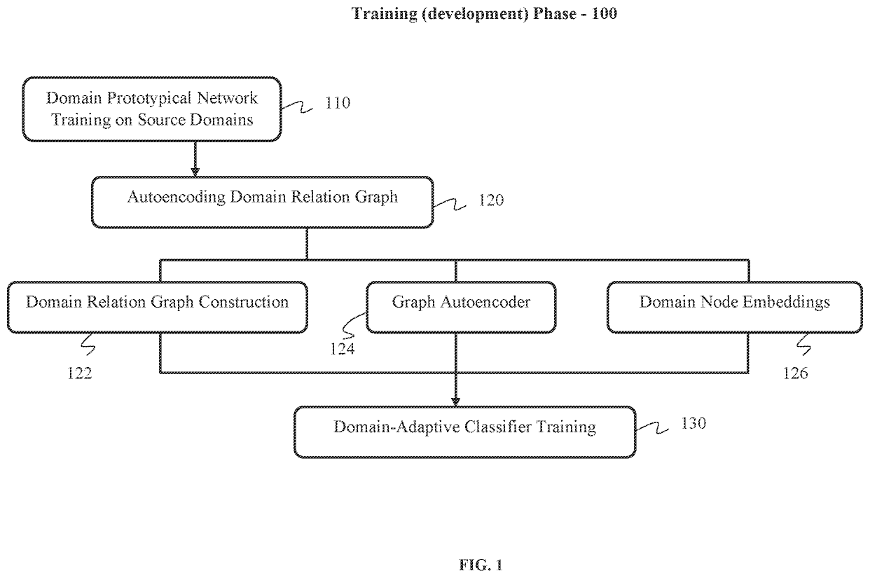

FIG. 1 is a block/flow diagram of a training phase of a graph-based adaptive domain generation framework, in accordance with embodiments of the present invention.

During the training (development) phase 100, given a set of unlabeled data samples from multiple source domains (110), the exemplary methods first train a domain prototypical network for extracting domain-specific features and capturing the similarity between each domain. Then at block 120, the exemplary methods construct a domain-relational graph 122, where each domain is represented as a node in the graph. Specifically, the prior knowledge vectors serve as the initial node embedding for each domain, and the edge weight is computed according to the similarity between the two domains, which is computed using the pre-trained domain prototypical network. After the domain graph is constructed, the exemplary methods apply a graph autoencoder 124 to produce more nuanced domain node embeddings 126. Finally, at block 130, the exemplary methods train a domain-adaptive classifier which considers both the input data sample as well as the corresponding domain node embedding to make an informed decision.

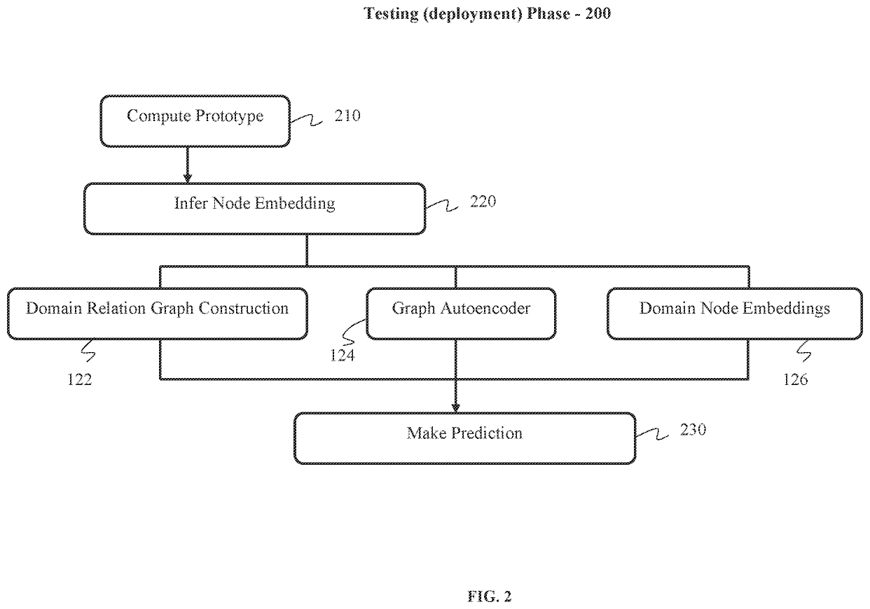

FIG. 2 is a block/flow diagram of a testing phase of the graph-based adaptive domain generation framework, in accordance with embodiments of the present invention.

In the testing (deployment) phase 200, given testing samples from the new domain, (block 210) the exemplary methods first compute their domain prototype using the pre-trained domain prototypical network. Then, at block 220, the exemplary methods add a new node to the existing domain graph to represent the new domain and compute its domain node embedding accordingly. Finally, at block 230, a prediction is made by the classifier conditioned on the computed domain node embedding.

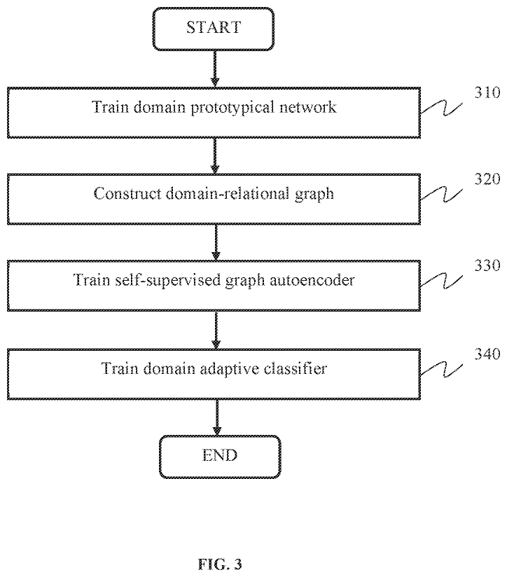

FIG. 3 is a block/flow diagram of an exemplary flow chart of the training procedure, in accordance with embodiments of the present invention.

At block 310, train a domain prototypical network.

At block 320, construct a domain-relational graph.

At block 330, train a self-supervised graph autoencoder.

At block 340, train domain adaptive classifier.

Regarding the domain prototypical network training at block 310, given a set of unlabeled data samples for each source domain, the exemplary methods first train a domain prototypical network to learn a low dimensional latent space where data samples from each domain are well-separated.

The training objective can be mathematically described as:

Lₚ(Φ)=−log p_{Φ}(d=k|x)

$${p}_{Φ} ( d = k \vert x ) = \frac{exp ( - d ( {f}_{Φ} ( x ) , {c}_{k} ) )}{{\sum }_{i = 1}^{K} exp ( - d ( {f}_{Φ} ( x ) , {c}_{i} )}$$

where f_{Φ}, denotes the domain prototypical network,

$${c}_{k} = \frac{1}{\vert {D}_{k} \vert} {\sum }_{x ∈ {D}_{k}} {f}_{Φ} ( x )$$

is the probability of the data sample x belonging to me true domain, is the prototype for the k-th source domain (Dₖ), and d(·, ·) is the distance metric.

Regarding the construction of the domain-relational graph at block 320, the exemplary methods use a graph data structure to represent the relationship of all data domains. Specifically, the exemplary methods use the prior knowledge vector vₖ for each domain as the initial node embedding.

The weight of the edge between two nodes vₖ and vₗ is computed as wₖₗ=exp(−d(cₖ, cₗ)).

Regarding training the self-supervised graph autoencoder, at block 330, to train the graph autoencoder in a self-supervised manner, the exemplary methods first prune (i.e., set the edge weight to be zero) r % of the edges with the smallest weight values. Then, a graph autoencoder is trained to produce node embeddings that can be used to infer the linkage of each edge. Mathematically, the exemplary methods calculate the node embeddings Z and the reconstructed adjacency matrix Â as Â=σ(ZZ^{T}), with Z=g_{GCN}(X, A), where g_{GCN} denotes the graph autoencoder composed of graph convolutional layers, X is a matrix that summarizes the initial node embeddings, and A represents the true adjacency matrix. The loss used for training the graph autoencoder is the binary cross-entropy loss.

Regarding the training of the domain adaptive classifier, at block 340, the exemplary methods train a domain adaptive classification model F_{θ} using labeled data from each source domain using the following loss function:

L_{c}(θ)=Σᵢ₌₁^{K}Σ_{x,y∈D}_{ᵢ}CE(F_{θ}(x,zᵢ),y)

where CE(·) denotes the categorical cross-entropy loss.

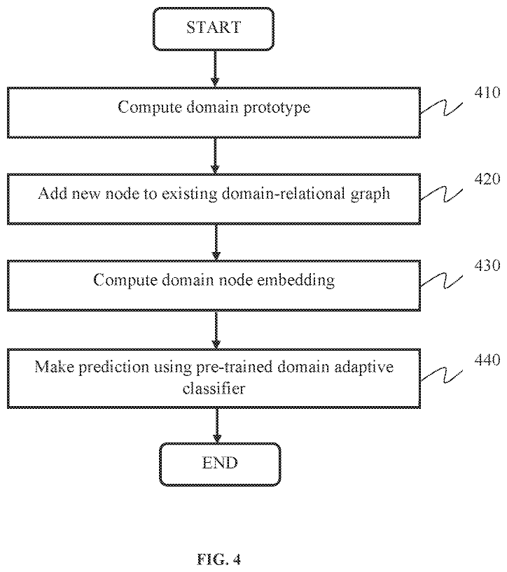

FIG. 4 is a block/flow diagram of an exemplary flow chart of the inference procedure, in accordance with embodiments of the present invention.

At block 410, compute a domain prototype.

At block 420, add a new node to the existing domain-relational graph.

At block 430, compute a domain node embedding.

At block 440, make a prediction by using a pretrained domain adaptive classifier.

Regarding computing the domain prototype, at block 410, at deployment time, given a set of unlabeled testing samples xₜ from the new domain Dₜ, the exemplary methods first compute its domain prototype using the pre-trained domain prototypical network:

$${c}_{t} = \frac{1}{\vert {D}_{t} \vert} {\sum }_{x ∈ {D}_{t}} {f}_{Φ} ( {x}_{t} ) .$$

Regarding adding a new node to the existing domain-relational graph, at block 420, to represent the new domain, the exemplary methods add a new node to the existing domain-relational graph, with the prior knowledge of the new domain vₜ as its initial node embedding, and the weight of its edges calculated accordingly using its protype computed in the previous step.

Regarding computing the domain node embedding, at block 430, the domain node embedding of the new domain (zₜ) is computed by applying the pre-trained graph autoencoder to the revised domain-relational graph.

Regarding making a prediction by using the pre-trained domain adaptive classifier, at block 440, a prediction for the testing samples is made by the pretrained classifier F_{θ} according to the computed domain node embedding: yₜ=F_{θ}(xₜ, zₜ).

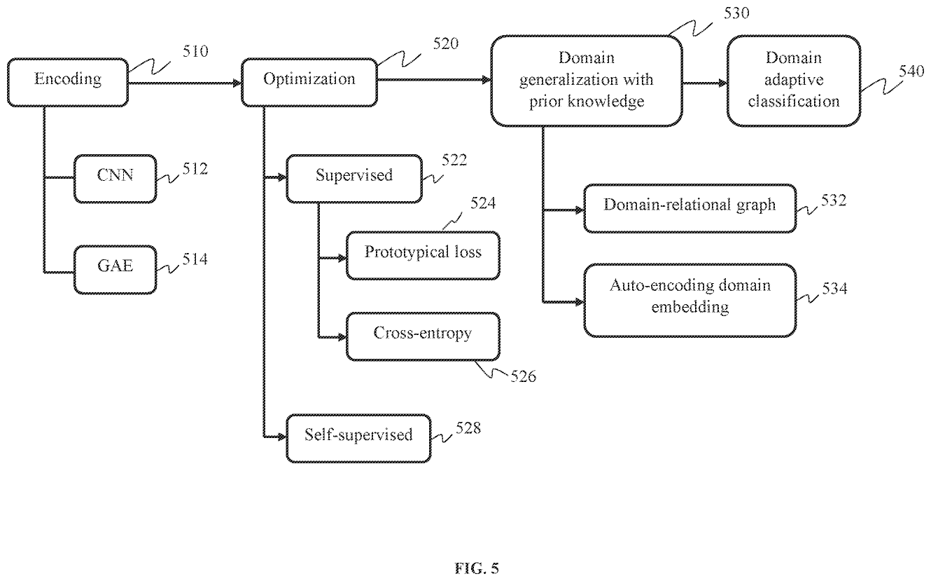

FIG. 5 is a block/flow diagram of an exemplary workflow of the domain generalization with prior knowledge and domain adaptive classification, in accordance with embodiments of the present invention.

The encoding 510 can be performed by using a convolutional neural network (CNN) 512 or a graph autoencoder (GAE) 514.

Optimization 520 includes supervised learning 522, which involves a prototypical loss 524 and cross-entropy 526. The optimization 520 can further include self-supervised learning 528.

At block 530, domain generalization with prior knowledge can be accomplished by using a domain-relational graph 532 and employing autoencoding domain embedding 534. Domain adaptive classification 540 can also be achieved by training the domain adaptive classifier.

Referring to FIG. 5, first, the exemplary methods utilize a domain-relational graph to encode domain prior knowledge as well as domain relationships encoded by pre-computed domain prototypes. Second, the exemplary methods extract compact domain node embedding from the domain-relational graph using a graph autoencoder in a self-supervised manner. Third, the exemplary methods employ a domain adaptive classification module which makes predictions depending on the computed domain node embedding.

Therefore, in summary, most state-of-the-art techniques only attempt to utilize the information extracted from source domain data while ignoring the prior information regarding the target domain. The key aspects of the exemplary embodiments are a domain prototypical network module, which aims to learn a good representation of each domain by training on unlabeled data from the source domains. The exemplary methods further introduce a domain-relational graph module, which models each domain as a node in a graph, with the prior knowledge vector as the initial node embedding and the similarity between the domain prototypes as the edge weight. Once the graph is constructed, a graph neural network-based autoencoder is used for producing domain embeddings. The exemplary methods further introduce a domain-adaptive classification module, which aims to make an informed prediction for each testing sample by utilizing the learned domain embedding from the previous step.

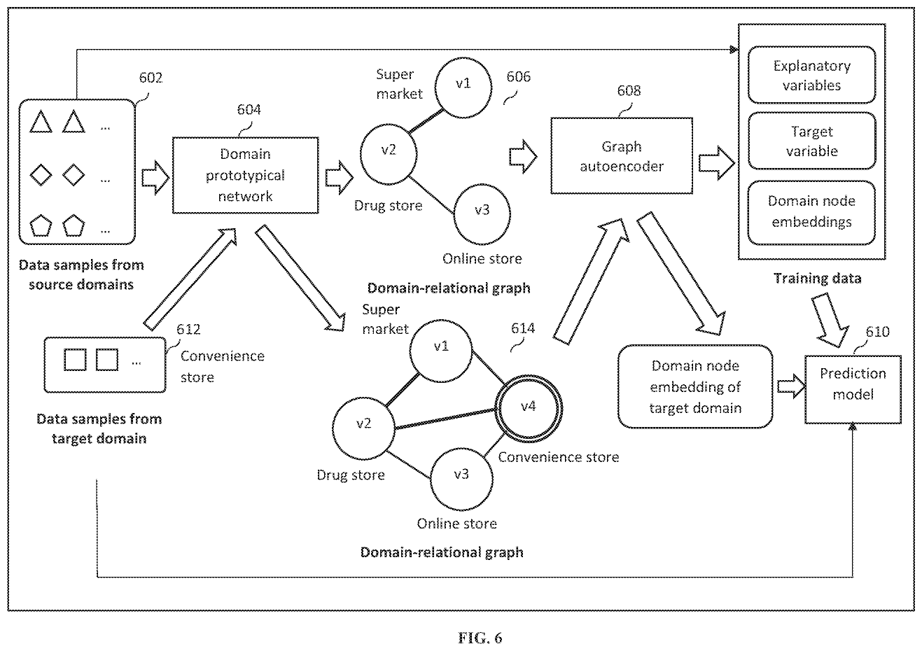

FIG. 6 is a block/flow diagram of an exemplary practical application of the graph-based adaptive domain generation framework, in accordance with embodiments of the present invention.

Regarding the training phase, training a domain prototypical network 604 using unlabeled data samples 602 from multiple source domains is presented.

Data samples 602 include samples from three domains, e.g., supermarket, drug store, and online store. Each domain can be arbitrarily set. The domain is the sales channel of health foods. Other examples of domains include the sales location of health foods (urban and suburban areas, one country and another, etc.) or product features of health foods (ingredients, price, sales, manufacturing company name).

Data samples should be related to the content that a user wants to predict. It is desirable for data samples to characterize the domain. When predicting sales of health foods in a new sales channel, data samples with a correlation to the sales of health foods collected for existing multiple sales channels can be used. For example, data samples may represent the average purchase amount of health foods per visitor in each of the supermarket, drug store, and online store.

A domain prototypical network 604 is generated by extracting domain-specific features from data samples 602 as described above.

Regarding constructing a domain-relational graph 606, domain-relational graph 606 includes nodes v1, v2, and v3, corresponding to the domain supermarket, drug store, and online store. The prior knowledge vectors serve as the initial node embedding for each domain, and the edge weight is computed according to the similarity between the two domains, which is computed using the domain prototypical network 604. The domain node embeddings for each domain can be generated from the domain-relational graph 606, thus generated using the graph autoencoder 608.

Regarding training a domain-adaptive classifier 610, data samples 602 are used as explanatory variables for the prediction model 610. Then, by training with training data that associates the target variable (specifically, the sales of health foods) with data samples 602 and generated domain node embeddings, the prediction model 610 that predicts the sales of health foods is generated.

Regarding the testing phase, domain prototypes of data samples 612 are computed from the new domain. The new domain is, e.g., a convenience store. The domain prototype is calculated for data samples 612 of the convenience store using the domain prototypical network 604.

Regarding adding a new node to the existing domain graph to represent the new domain and compute its domain node embedding, domain-relational graph 606 is updated with the addition of a new node v4 to represent the convenience store, resulting in a new domain-relational graph 614. The domain node embedding for the target domain, e.g., convenience store, is generated from the domain-relational graph 614 using the graph autoencoder 608.

Regarding the predicting of health food sales, the prediction model 610 is used with the generated domain node embedding and data samples 612 as input to obtain the predicted sales of health foods. This allows obtaining reasonable predictions specific to the convenience store domain without using data samples collected from the convenience store, using only the prediction model 610 generated without relying on data samples from the convenience store domain.

Other practical applications can include any inference model that performs inference related to a specific domain (region, target, scope, etc.) generated from data samples acquired for a portion of the domains and may be applied to improve inference accuracy for inference in other domains. For example, a predictive model that predicts the optimal rehabilitation menu for a patient based on data samples collected from a specific patient group may be generated. In this case, patients can be classified into categories based on their attributes such as gender, age, and symptoms, and each category can be treated as a domain. This enables predicting the optimal rehabilitation menu for patients who do not fit into existing categories (e.g., those who belong to new domains).

Therefore, the inventive features of the exemplary embodiments include at least a domain-relational graph that utilizes the prior information about domains as an initial node embedding and similarity between domain prototypes as edge weights, and a graph autoencoder that extracts useful domain embeddings based on the constructed domain graph, and a domain-adaptive classification module that leverages the extracted domain embeddings to make adaptive decisions.

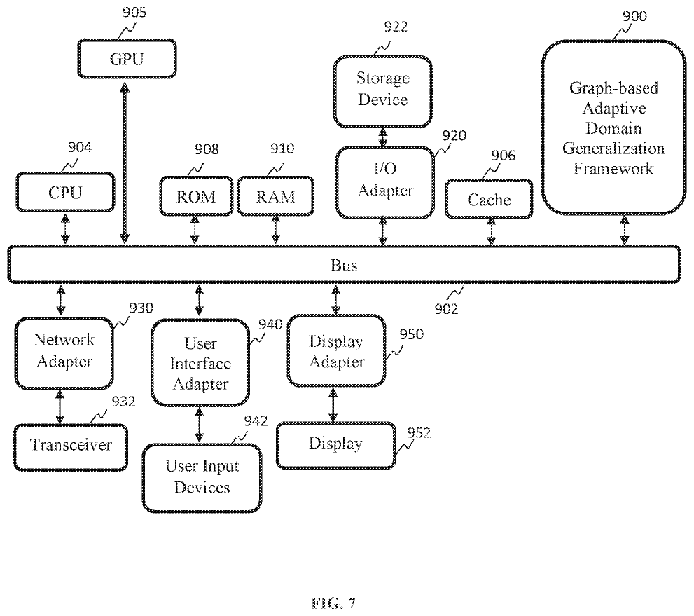

FIG. 7 is an exemplary processing system for employing the graph-based adaptive domain generation framework, in accordance with embodiments of the present invention.

The processing system includes at least one processor (CPU) 904 operatively coupled to other components via a system bus 902. A GPU 905, a cache 906, a Read Only Memory (ROM) 908, a Random Access Memory (RAM) 910, an input/output (I/O) adapter 920, a network adapter 930, a user interface adapter 940, and a display adapter 950, are operatively coupled to the system bus 902. Additionally, a graph-based adaptive domain generation framework 900 is employed.

A storage device 922 is operatively coupled to system bus 902 by the I/O adapter 920. The storage device 922 can be any of a disk storage device (e.g., a magnetic or optical disk storage device), a solid-state magnetic device, and so forth.

A transceiver 932 is operatively coupled to system bus 902 by network adapter 930.

User input devices 942 are operatively coupled to system bus 902 by user interface adapter 940. The user input devices 942 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present invention. The user input devices 942 can be the same type of user input device or different types of user input devices. The user input devices 942 are used to input and output information to and from the processing system.

A display device 952 is operatively coupled to system bus 902 by display adapter 950.

Of course, the processing system may also include other elements (not shown), as readily contemplated by one of skill in the art, as well as omit certain elements. For example, various other input devices and/or output devices can be included in the system, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system are readily contemplated by one of ordinary skill in the art given the teachings of the present invention provided herein.

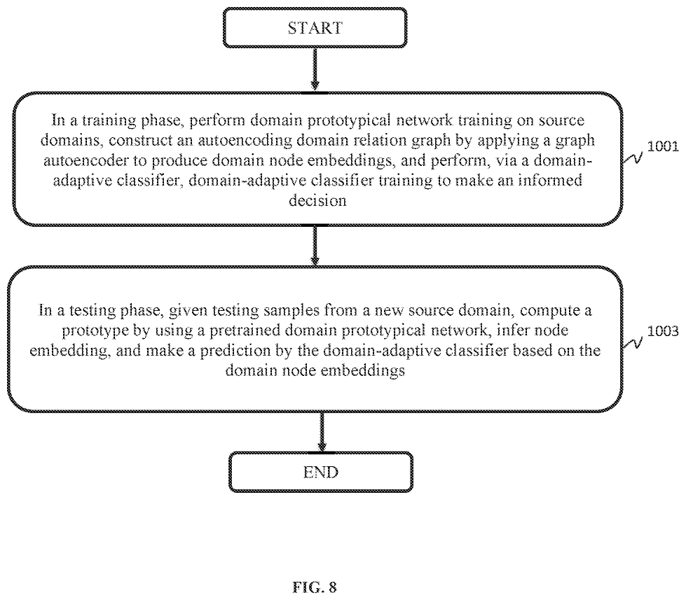

FIG. 8 is a block/flow diagram of an exemplary method for employing the graph-based adaptive domain generation framework, in accordance with embodiments of the present invention.

At block 1001, in a training phase, perform domain prototypical network training on source domains, construct an autoencoding domain relation graph by applying a graph autoencoder to produce domain node embeddings, and perform, via a domain-adaptive classifier, domain-adaptive classifier training to make an informed decision.

At block 1003, in a testing phase, given testing samples from a new source domain, compute a prototype by using a pretrained domain prototypical network, infer node embedding, and make a prediction by the domain-adaptive classifier based on the domain node embeddings.

As used herein, the terms “data,” “content,” “information” and similar terms can be used interchangeably to refer to data capable of being captured, transmitted, received, displayed and/or stored in accordance with various example embodiments. Thus, use of any such terms should not be taken to limit the spirit and scope of the disclosure. Further, where a computing device is described herein to receive data from another computing device, the data can be received directly from the another computing device or can be received indirectly via one or more intermediary computing devices, such as, for example, one or more servers, relays, routers, network access points, base stations, and/or the like. Similarly, where a computing device is described herein to send data to another computing device, the data can be sent directly to the another computing device or can be sent indirectly via one or more intermediary computing devices, such as, for example, one or more servers, relays, routers, network access points, base stations, and/or the like.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” “calculator,” “device,” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical data storage device, a magnetic data storage device, or any suitable combination of the foregoing. In the context of this document, a computer readable storage medium may be any tangible medium that can include, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks or modules.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks or modules.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks or modules.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for employing a graph-based adaptive domain generation framework, the method comprising:
in a training phase:
performing domain prototypical network training on source domains;
constructing an autoencoding domain relation graph by applying a graph autoencoder to produce domain node embeddings; and
performing, via a domain-adaptive classifier, domain-adaptive classifier training to make an informed decision; and
in a testing phase, given testing samples from a new source domain:
computing a prototype by using a pretrained domain prototypical network;
inferring node embedding; and
making a prediction by the domain-adaptive classifier based on the domain node embeddings.

2. The computer-implemented method of claim 1, wherein the domain prototypical network training results in extracting domain-specific features and capturing a similarity between the source domains.

3. The computer-implemented method of claim 1, wherein prior knowledge vectors serve as an initial node embedding for each source domain.

4. The computer-implemented method of claim 1, wherein an edge weight is computed according to a similarity between two source domains.

5. The computer-implemented method of claim 1, wherein the inferring of new embeddings includes adding a new node to an existing domain graph to represent the new source domain.

6. The computer-implemented method of claim 1, wherein the graph autoencoder is trained to produce the node embeddings used to infer a linkage of each edge.

7. The computer-implemented method of claim 1, wherein the pretrained domain prototypical network learns a representation of each source domain by training on unlabeled data from the source domains.

8. A computer program product for employing a graph-based adaptive domain generation framework, the computer program product comprising a non-transitory computer readable storage medium having program instructions embodied therewith, the program instructions executable by a computer to cause the computer to perform a method comprising:
in a training phase:
performing domain prototypical network training on source domains;
constructing an autoencoding domain relation graph by applying a graph autoencoder to produce domain node embeddings; and
performing, via a domain-adaptive classifier, domain-adaptive classifier training to make an informed decision; and
in a testing phase, given testing samples from a new source domain:
computing a prototype by using a pretrained domain prototypical network;
inferring node embedding; and
making a prediction by the domain-adaptive classifier based on the domain node embeddings.

9. The computer program product of claim 8, wherein the domain prototypical network training results in extracting domain-specific features and capturing a similarity between the source domains.

10. The computer program product of claim 8, wherein prior knowledge vectors serve as an initial node embedding for each source domain.

11. The computer program product of claim 8, wherein an edge weight is computed according to a similarity between two source domains.

12. The computer program product of claim 8, wherein the inferring of new embeddings includes adding a new node to an existing domain graph to represent the new source domain.

13. The computer program product of claim 8, wherein the graph autoencoder is trained to produce the node embeddings used to infer a linkage of each edge.

14. The computer program product of claim 8, wherein the pretrained domain prototypical network learns a representation of each source domain by training on unlabeled data from the source domains.

15. A computer processing system for employing a graph-based adaptive domain generation framework, comprising:
a memory device for storing program code; and
a processor device, operatively coupled to the memory device, for running the program code to:
in a training phase:
perform domain prototypical network training on source domains;
construct an autoencoding domain relation graph by applying a graph autoencoder to produce domain node embeddings; and
perform, via a domain-adaptive classifier, domain-adaptive classifier training to make an informed decision; and
in a testing phase, given testing samples from a new source domain:
compute a prototype by using a pretrained domain prototypical network;
infer node embedding; and
make a prediction by the domain-adaptive classifier based on the domain node embeddings.

16. The computer processing system of claim 15, wherein the domain prototypical network training results in extracting domain-specific features and capturing a similarity between the source domains.

17. The computer processing system of claim 15, wherein prior knowledge vectors serve as an initial node embedding for each source domain.

18. The computer processing system of claim 15 wherein an edge weight is computed according to a similarity between two source domains.

19. The computer processing system of claim 15, wherein the inferring of new embeddings includes adding a new node to an existing domain graph to represent the new source domain.

20. The computer processing system of claim 15, wherein the graph autoencoder is trained to produce the node embeddings used to infer a linkage of each edge.
